(19) United States
(12) Patent Application Publication
(10) Pub. No.: US 2025/0384669 A1
(43) Pub. Date: Dec. 18, 2025

(54) DEVICE AND METHOD FOR RETRIEVING MULTIMODAL OBJECT BASED ON COMPOSITE EMBEDDING

(71) Applicant: Electronics and Telecommunications Research Institute, Daejeon (KR)

(72) Inventors: Joon Young JUNG, Daejeon (KR); Dong-oh Kang, Daejeon (KR); Minho Park, Daejeon (KR); Eun-ju Jeong, Daejeon (KR)

(73) Assignee: Electronics and Telecommunications Research Institute, Daejeon (KR)

(21) Appl. No.: 18/965,007

(22) Filed: Dec. 2, 2024

(30) Foreign Application Priority Data
Jun. 13, 2024 (KR) 10-2024-0077049

(51) Int. Cl. G06V 10/774; G06F 40/279; G06V 10/74; G06V 10/776

(52) U.S. Cl. CPC G06V 10/774; G06F 40/279; G06V 10/761; G06V 10/776

(57) ABSTRACT

Provided are a device and method for extracting a multimodal object on the basis of composite embedding. The device extracts training natural language text and training images from a training data storage, generates image composite embeddings including embeddings of the training images and key objects included in the training images, generates natural language composite embeddings on the basis of the training natural language text, and measure multimodal similarities between the image composite embeddings and the natural language composite embeddings.

### CROSS-REFERENCE TO RELATED APPLICATION

This application claims priority to and the benefit of Korean Patent Application No. 10-2024-0077049, filed on Jun. 13, 2024, the disclosure of which is incorporated herein by reference in its entirety.

### BACKGROUND

### 1. Field of the Invention

The present invention relates to a device and method for extracting an image object having the same meaning as a natural language in a multimodal environment on the basis of composite embedding using deep learning.

### 2. Discussion of Related Art

Multimodal object extraction for recognizing the connection between a natural language and an image and extracting an image object related to the natural language, is being researched on the basis of artificial intelligence (AI). Lately, AI models pretrained using a huge amount of data have been provided to recognize the connection between a natural language and an image.

For multimodal object extraction, a natural language and an image are recognized to measure the similarity between the natural language and the image. To this end, each of the natural language and the image is embedded, and similarity is measured between the natural language embedding and the image embedding. However, image data and natural language data may be simple or complex. For example, in the case of natural language data, there is a simple sentence such as “Get me the milk,” and there is a complex sentence such as “I am proud of my son for waking up early this morning, washing his face and brushing his teeth as usual in spite of his young age, and I would like to give him some fresh milk to go with his apple and egg to help him grow up healthy, and I wonder if you could see if there is any delivered milk from the cow farm this morning and bring it to me so that I can help him grow up healthy and strong.” The accuracy of multimodal object extraction is affected by data used to train an AI model, and it may be difficult for an AI model trained to extract image objects associated with simple natural language text to accurately extract image objects associated with complex natural language text. Also, an AI model trained using images only including simple image objects may not be appropriate for extracting an image object associated with a natural language from an image including various image objects. Therefore, a method and device are necessary to determine the meanings of complex natural language text and a complex image and accurately extract a multimodal object.

### SUMMARY OF THE INVENTION

The present invention is directed to providing a device and method for extracting a multimodal object on the basis of composite embedding to accurately extract a multimodal object from a complex natural language and complex image data.

Specifically, the present invention is directed to providing a device and method for extracting a multimodal object on the basis of composite embedding, which generate a natural language embedding including an overall sentence embedding and key word embedding information of a natural language, generate an image embedding including overall image embedding and key object embedding information of an image to be extracted, and extract an image that is most closely related to the natural language from a large number of images using the natural language embedding and the image embedding.

Objects of the present invention are not limited to those described above, and other objects which have not been described will be clearly understood by those of ordinary skill in the art from the following description.

According to an aspect of the present invention, there is provided a device for extracting a multimodal object on the basis of composite embedding, the device including a training data extraction module configured to extract training natural language text and training images from a training data storage, an image composite embedding generation module configured to generate image composite embeddings including embeddings of the training images and key objects included in the training images, a natural language composite embedding generation module configured to generate natural language composite embeddings including embeddings of the training natural language text and key words included in the training natural language text, and a multimodal similarity measurement module configured to measure multimodal similarities between the image composite embeddings and the natural language composite embeddings.

The device may further include an error measurement module configured to measure errors of the multimodal similarities on the basis of ground truth information extracted from the training data storage.

The training data extraction module may extract a positive image related to the training natural language text from the training data storage, extract one or more negative images unrelated to the training natural language text from the training data storage, and configure (generate) the training images including the positive image and the negative images.

The image composite embedding generation module may generate image embeddings for the training images using an image embedding model, extract the key objects from the training images using a key object extraction model, generate key object embeddings which are the embeddings for the key objects using a key object embedding model, and generate the image composite embeddings on the basis of the image embeddings and the key object embeddings.

The natural language composite embedding generation module may generate natural language embeddings which are the embeddings of the training natural language text using a natural language embedding model, extract the key words of the training natural language text using a key word extraction model, generate key word embeddings which are the embeddings of the key words using the natural language embedding model, and generate the natural language composite embeddings on the basis of the natural language embeddings and the key word embeddings.

The image composite embedding generation module may update parameters of the image embedding model and the key object embedding model on the basis of errors of the multimodal similarities.

The natural language composite embedding generation module may update parameters of the natural language embedding model on the basis of errors of the multimodal similarities.

According to another aspect of the present invention, there is provided a device for extracting a multimodal object on the basis of composite embedding, the device including an image composite embedding generation module configured to generate, for each of training images stored in a training data storage, image composite embeddings including image embeddings for all the training images and key object embeddings which are embeddings of key objects included in all the training images and store the image composite embeddings in an image composite embedding storage, a training data extraction module configured to extract training natural language text and one or more training images from the training data storage, a natural language composite embedding generation module configured to generate natural language composite embeddings including embeddings of the training natural language text and key words included in the training natural language text, an image composite embedding extraction module configured to extract image composite embeddings matching the one or more training images from the image composite embedding storage, and a multimodal similarity measurement module configured to measure multimodal similarities between the image composite embeddings matching the one or more training images and the natural language composite embeddings.

The image composite embedding generation module may generate the image embeddings using an image embedding model, extract the key objects from all the training images using a key object extraction model, generate the key object embeddings using a key object embedding model, and generate the image composite embeddings on the basis of the image embeddings and the key object embeddings.

The image embedding model and the key object embedding model may be pretrained models.

The natural language composite embedding generation module may generate natural language embeddings which are the embeddings of the training natural language text using a natural language embedding model, extract the key words of the training natural language text using a key word extraction model, generate key word embeddings which are the embeddings of the key words using the natural language embedding model, generate the natural language composite embeddings on the basis of the natural language embeddings and the key word embeddings, and update parameters of the natural language embedding model on the basis of errors of the multimodal similarities.

According to another aspect of the present invention, there is provided a method of extracting a multimodal object on the basis of composite embedding, the method including extracting, by a training data extraction module, training natural language text and training images from a training data storage, generating, by an image composite embedding generation module, image composite embeddings including embeddings of the training images and the key objects included in the training images, generating, by a natural language composite embedding generation module, natural language composite embeddings including embeddings of the training natural language text and the key words included in the training natural language text, and measuring, by a multimodal similarity measurement module, multimodal similarities between the image composite embeddings and the natural language composite embeddings.

The method may further include measuring, by an error measurement module, errors of the multimodal similarities on the basis of ground truth information extracted from the training data storage.

The extracting of the training natural language text and the training images may include extracting, by the training data extraction module, a positive image related to the training natural language text from the training data storage, extracting one or more negative images unrelated to the training natural language text from the training data storage, and configuring (generating) the training images including the positive image and the negative images.

The generating of the image composite embedding may include generating, by the image composite embedding generation module, image embeddings for the training images using an image embedding model, extracting the key objects from the training images using a key object extraction model, generating key object embeddings which are the embeddings for the key objects using a key object embedding model, and generating the image composite embeddings on the basis of the image embeddings and the key object embeddings.

The generating of the natural language composite embeddings may include generating, by the natural language composite embedding generation module, natural language embeddings which are the embeddings of the training natural language text using a natural language embedding model, extracting the key words of the training natural language text using a key word extraction model, generating key word embeddings which are the embeddings of the key words using the natural language embedding model, and generating the natural language composite embeddings on the basis of the natural language embeddings and the key word embeddings.

The method may further include updating, by the image composite embedding generation module, parameters of the image embedding model and the key object embedding model on the basis of errors of the multimodal similarities.

The method may further include updating, by the natural language composite embedding generation module, parameters of the natural language embedding model on the basis of errors of the multimodal similarities.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a device for extracting a multimodal object on the basis of composite embedding according to a first exemplary embodiment of the present invention;

FIG. 2 is a diagram illustrating an image composite embedding generation process of an image composite embedding generation module according to the first exemplary embodiment of the present invention;

FIG. 3 is a diagram illustrating a natural language composite embedding generation process of a natural language composite embedding generation module according to the first exemplary embodiment of the present invention;

FIG. 4 is a block diagram of a device for extracting a multimodal object on the basis of composite embedding according to a second exemplary embodiment of the present invention;

FIG. 5 is a diagram illustrating an image composite embedding extraction process of an image composite embedding extraction module according to the second exemplary embodiment of the present invention;

FIG. 6 is a block diagram of a device for extracting a multimodal object on the basis of composite embedding according to a third exemplary embodiment of the present invention;

FIG. 7 is a diagram illustrating a natural language composite embedding extraction process of a natural language composite embedding extraction module according to the third exemplary embodiment of the present invention;

FIG. 8 is a flowchart illustrating a method of extracting a multimodal object on the basis of composite embedding according to the first exemplary embodiment of the present invention;

FIG. 9 is a flowchart illustrating a method of extracting a multimodal object on the basis of composite embedding according to the second exemplary embodiment of the present invention;

FIG. 10 is a flowchart illustrating a method of extracting a multimodal object on the basis of composite embedding according to the third exemplary embodiment of the present invention; and

FIG. 11 is a block diagram of a computer system for implementing a method of extracting a multimodal object on the basis of composite embedding according to an exemplary embodiment of the present invention.

### DETAILED DESCRIPTION OF EXEMPLARY EMBODIMENTS

The present invention relates to a device and method for extracting a multimodal object on the basis of composite embedding to extract an image object having the same meaning as a natural language in a multimodal environment on the basis of composite embedding using deep learning. More specifically, a device and method for extracting a multimodal object on the basis of composite embedding, which generate a natural language embedding including an overall sentence embedding and key word embedding information of a natural language, generate an image embedding including overall image embedding and key object embedding information of an image to be extracted, and extract an image that is most closely related to the natural language from a large number of images using the natural language embedding and the image embedding.

Advantages and features of the present invention and methods of achieving them will become clear with reference to exemplary embodiments described below in detail in conjunction with the accompanying drawings. However, the present invention is not limited to the embodiments disclosed below and may be implemented in various different forms. The embodiments are provided only to make the disclosure of the present invention complete and fully convey the scope of the present invention to those skilled in the technical field to which the present invention pertains, and the present invention is only defined by the scope of the claims. Meanwhile, terminology used herein is for describing the embodiments and is not intended to limit the present invention. In this specification, singular forms also include plural forms unless specifically stated otherwise. As used herein, “comprise” and/or “comprising” do not preclude the presence or addition of one or more components, steps, operations, and/or elements other than stated components, steps, operations, and/or elements.

Although the terms “first,” “second,” and the like may be used to describe various components, the components are not limited by the terms. These terms are only used to distinguish one component from others. For example, without departing the scope of the present invention, a first component may be named a second component, and similarly, a second component may be named a first component.

When a component is referred to as being “connected” or “coupled” to another component, it should be understood that the two components may be directly coupled or connected to each other, or still another component may be interposed therebetween. On the other hand, when a component is referred to as being “directly connected” or “directly coupled” to another component, it should be understood that there is no intermediate component. Other expressions describing relationships between components, such as “between,” “directly between,” “neighboring,” “directly neighboring,” and the like, should be similarly interpreted.

In describing the present invention, detailed description of related well-known technology that is determined to unnecessarily obscure the subject matter of the present invention will be omitted.

Hereinafter, exemplary embodiments of the present invention will be described in detail with reference to the accompanying drawings. In describing the present invention, to facilitate overall understanding, the same reference numeral will be used for the same element throughout the drawings.

The present specification discloses a device and method for extracting a multimodal object on the basis of composite embedding to recognize an image having a meaning related to a natural language from the natural language and image data using a composite embedding-based deep learning model.

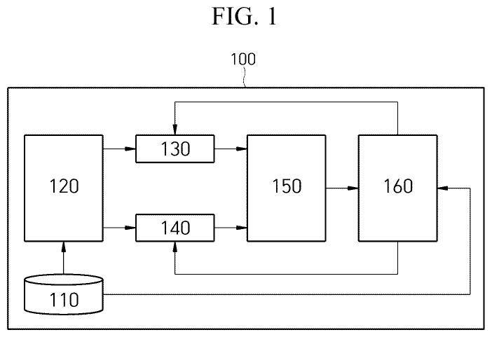

Functions of modules included in a device for extracting a multimodal object on the basis of composite embedding will be described below with reference to FIGS. 1 to 7.

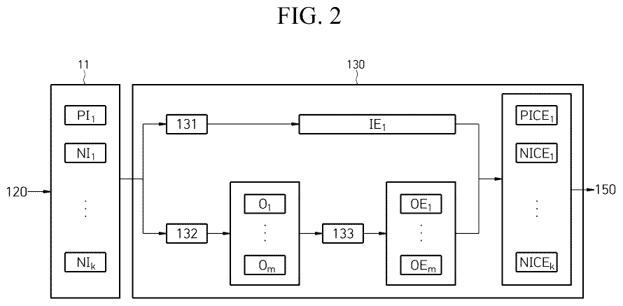

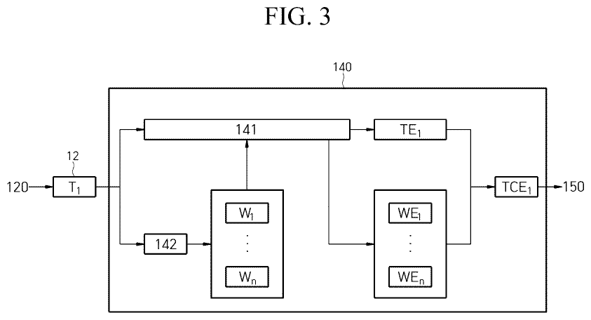

FIG. 1 is a block diagram of a device for extracting a multimodal object on the basis of composite embedding according to a first exemplary embodiment of the present invention, FIG. 2 is a diagram illustrating an image composite embedding generation process of an image composite embedding generation module according to the first exemplary embodiment of the present invention, and FIG. 3 is a diagram illustrating a natural language composite embedding generation process of a natural language composite embedding generation module according to the first exemplary embodiment of the present invention.

Functions of a device 100 for extracting a multimodal object on the basis of composite embedding according to the first exemplary embodiment of the present invention will be described below with reference to FIGS. 1 to 3.

Referring to FIG. 1, the device 100 for extracting a multimodal object on the basis of composite embedding according to the exemplary embodiment of the present invention includes a training data storage 110, a training data extraction module 120, an image composite embedding generation module 130, a natural language composite embedding generation module 140, a multimodal similarity measurement module 150, and an error measurement module 160. The device 100 for extracting a multimodal object on the basis of composite embedding shown in FIG. 1 is in accordance with the exemplary embodiment, and components of the device 100 for extracting a multimodal object on the basis of composite embedding according to the present invention are not limited to the embodiment shown in FIG. 1 and may be added, changed, or removed as necessary.

The training data storage 110 stores training images 11 and training natural language text 12 used for training deep learning models, such as an image embedding model 131, a key object extraction model 132, an object embedding model 133, a natural language embedding model 141, a key word extraction model 142, and the like, using supervised learning.

The training data extraction module 120 extracts the training natural language text 12 from the training data storage 110 and extracts one positive image PI₁ related to the training natural language text 12 extracted from the training data storage 110 and k negative images NI₁, . . . , and NIₖ unrelated to the extracted training natural language text 12. Here, k is a natural number of 1 or more. The positive image PI₁ and the plurality of negative images NI₁, . . . , and NIₖ are the training images 11. For deep learning of the image composite embedding generation module 130 and the natural language composite embedding generation module 140, the training data extraction module 120 provides the training images 11 and the training natural language text 12 to the image composite embedding generation module 130 and the natural language composite embedding generation module 140, respectively.

As shown in FIG. 2, the image composite embedding generation module 130 generates k+1 image composite embeddings using the image embedding model 131, the key object extraction model 132, and the object embedding model 133 on the basis of the training images 11 received from the training data extraction module 120.

As a deep learning model, the image embedding model 131 receives the training images 11 and generates image embeddings for each of the training images PI₁, NI₁, . . . , and NIₖ. For example, the image embedding model 131 receives a positive image (e.g., PI₁) and generates an image embedding (e.g., IE₁).

As a deep learning model, the key object extraction model 132 extracts key objects from the training images 11. For example, the key object extraction model 132 receives a positive image (e.g., PI₁) and extracts key objects O₁, . . . , and Oₘ from the positive image. Here, m is an integer of 0 or more. For example, after performing segmentation, the key object extraction model 132 may apply criteria, such as size (the largest object), location (an object at the center), color (an object with different color from surroundings), and the like, to extract key objects. The key object extraction model 132 may be a well-known object detection model. For example, the key object extraction model 132 may be a You Only Look Once (YOLO) model or a faster recurrent convolutional neural network (RCNN)-based model.

As a deep learning model, the key object embedding model 133 receives key objects and generates embeddings (key object embeddings) for each of the key objects. For example, the object embedding model 133 may receive the key objects O₁, . . . , and Oₘ and generates key object embeddings OE₁, . . . , and OEₘ for each of the key objects.

The image composite embedding generation module 130 generates an image composite embedding (e.g., PICE₁) on the basis of an image embedding (e.g., IE₁) for a specific training image (e.g., PI₁) and key object embeddings (e.g., OE₁, . . . , and OEₘ). For example, the image composite embedding generation module 130 may generate image composite embeddings PICE₁, NICE₁, . . . , and NICEₖ by concatenating the image embeddings and key object embeddings of the k+1 training images PI₁, NI₁, . . . , and NIₖ, respectively.

As shown in FIG. 3, the natural language composite embedding generation module 140 generates a natural language composite embedding TCE₁ using the natural language embedding model 141 and the key word extraction model 142 on the basis of the training natural language text 12 (T₁) received from the training data extraction module 120. The training natural language text 12 (T₁) may include one sentence or a plurality of sentences.

As a deep learning model, the natural language embedding model 141 receives the training natural language text 12 (T₁) and generate a natural language embedding TE₁ which is an embedding for the natural language text.

As a deep learning model, the key word extraction model 142 receives the training natural language text 12 (T₁) and extracts n key words W₁, . . . , and Wₙ from the received training natural language text 12 (T₁). n is an integer of 0 or more. For example, the key word extraction model 142 may extract key words from the training natural language text 12 on the basis of information about frequencies, positions, co-occurrence, and the like of words included in the training natural language text 12.

The natural language composite embedding generation module 140 inputs the key words W₁, . . . , and Wₙ to the natural language embedding model 141 to generate key word embeddings WE₁, . . . , and WEₙ.

The natural language composite embedding generation module 140 generates the natural language composite embedding TCE₁ on the basis of the natural language embedding TE₁ and the n key word embeddings WE₁, . . . , and WEₙ. For example, the natural language composite embedding generation module 140 may generate the natural language composite embedding TCE₁ by concatenating the natural language embedding TE₁ and the n key word embeddings WE₁, . . . , and WEₙ.

Referring back to FIG. 1, functions of the multimodal similarity measurement module 150 and the error measurement module 160 will be described.

The multimodal similarity measurement module 150 measures similarity between the natural language composite embedding TCE₁ and each of the image composite embeddings PICE₁, NICE₁, . . . , and NICEₖ. In other words, the multimodal similarity measurement module 150 generates k+1 multimodal similarities by measuring similarity between one natural language composite embedding and the k+1 image composite embeddings.

The error measurement module 160 measures errors of the multimodal similarities generated by the multimodal similarity measurement module 150 using the multimodal similarities and ground truth information extracted from the training data storage 110. In the present specification, the term “ground truth information” represents information indicating whether a specific image is a positive image related to specific text or a negative image unrelated thereto. The error measurement module 160 may measure the errors of the multimodal similarities using an error measurement technique used in contrastive learning.

The image composite embedding generation module 130 trains the image embedding model 131, the key object extraction model 132, and the object embedding model 133 (trains parameters of the models) on the basis of the measured errors, and the natural language composite embedding generation module 140 trains the natural language embedding model 141 and the key word extraction model 142 (updates parameters of the models) on the basis of the measured errors. In other words, the image composite embedding generation module 130 and the natural language composite embedding generation module 140 train deep learning natural language and image models to reduce an error in multimodal object extraction based on composite embedding.

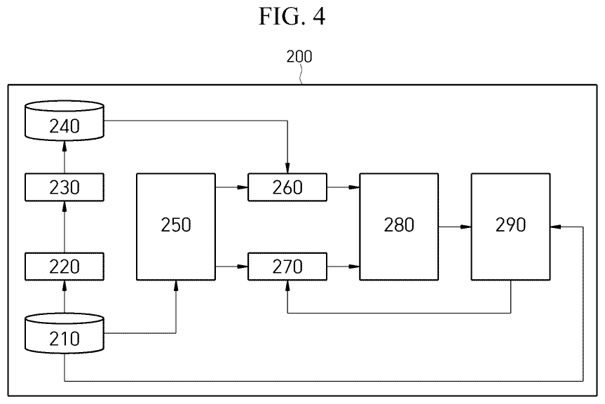

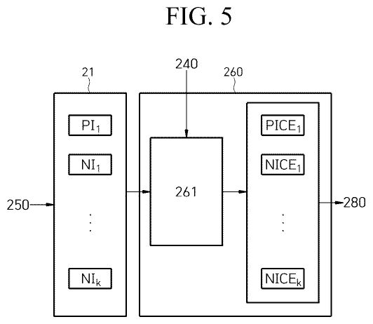

FIG. 4 is a block diagram of a device for extracting a multimodal object on the basis of composite embedding according to a second exemplary embodiment of the present invention, and FIG. 5 is a diagram illustrating an image composite embedding extraction process of an image composite embedding extraction module according to the second exemplary embodiment of the present invention.

Functions of a device 200 for extracting a multimodal object on the basis of composite embedding according to the second exemplary embodiment of the present invention will be described below with reference to FIGS. 4 and 5.

The device 200 for extracting a multimodal object on the basis of composite embedding according to the second exemplary embodiment of the present invention primarily performs an image composite embedding generation process and then performs an image composite embedding extraction process and a natural language composite embedding generation process.

Referring to FIG. 4, the device 200 for extracting a multimodal object on the basis of composite embedding according to an exemplary embodiment of the present invention includes a training data storage 210, an image extraction module 220, an image composite embedding generation module 230, an image composite embedding storage 240, a training data extraction module 250, an image composite embedding extraction module 260, a natural language composite embedding generation module 270, a multimodal similarity measurement module 280, and an error measurement module 290. The device 200 for extracting a multimodal object on the basis of composite embedding shown in FIG. 4 is in accordance with the exemplary embodiment, and components of the device 200 for extracting a multimodal object on the basis of composite embedding according to the present invention are not limited to the embodiment shown in FIG. 4 and may be added, changed, or removed as necessary.

The training data storage 210 stores the same data as data in the training data storage 110 of the first exemplary embodiment. In other words, the training data storage 210 stores training natural language text and training images required for training a deep learning model using supervised learning.

The image extraction module 220 and the image composite embedding generation module 230 operate prior to the training data extraction module 250, the image composite embedding extraction module 260, and the natural language composite embedding generation module 270.

The image extraction module 220 extracts training images 21 from the training data storage 210 and transmits the training images 21 to the image composite embedding generation module 230, and the image composite embedding generation module 230 generates image composite embeddings on the basis of the training images 21 and stores the image composite embeddings in the image composite embedding storage 240.

The image composite embedding generation module 230 has the same components and functions as those of the image composite embedding generation module 130. Accordingly, detailed description thereof will be omitted here. However, an image embedding model 231 (not shown), a key object extraction model 232 (not shown), and an object embedding model 233 (not shown) included in the image composite embedding generation module 230 may be pretrained models. This is because the device 200 for extracting a multimodal object on the basis of composite embedding only trains deep learning models of the natural language composite embedding generation module 270 on the basis of errors of the error measurement module 290.

The operations of the image extraction module 220 and the image composite embedding generation module 230 described above may be performed for all training images 21 stored in the training data storage 210. In other words, the image composite embedding generation module 230 may generate image composite embeddings for all the training images 21 stored in the training data storage 210 and store the image composite embeddings in the image composite embedding storage 240. The training images 21 of the training data storage 210 and the image composite embeddings which are generated on the basis of the training images 21 and stored in the image composite embedding storage 240 may be matched to each other through the same identifiers. In other words, the image composite embedding generation module 230 may assign the same identifier to a training image 21 and an image composite embedding to store the image composite embedding in the image composite embedding storage 240.

Meanwhile, the training data extraction module 250 extracts training natural language text 22 (not shown) from the training data storage 210, transmits the training natural language text 22 to the natural language composite embedding generation module 270, extracts one positive image related to the extracted training natural language text 22 and k negative images unrelated to the extracted training natural language text 22, that is, the training images 21, from the training data storage 210, and transmits the training images 21 to the image composite embedding extraction module 260. k is a natural number of 1 or more. Since the process in which the natural language composite embedding generation module 270 generates natural language composite embeddings on the basis of the training natural language text 22 and transmits the natural language composite embeddings to the multimodal similarity measurement module 280 is the same as the process in which the natural language composite embedding generation module 140 generates natural language composite embeddings on the basis of the training natural language text 12 and transmits the natural language composite embeddings to the multimodal similarity measurement module 150, detailed description thereof will be omitted here.

As shown in FIG. 5, the image composite embedding extraction module 260 extracts image composite embeddings (e.g., PICE₁, NICE₁, . . . , and NICEₖ) having the same identifiers as images (e.g., PI₁, NI₁, . . . , and NIₖ) included in the training images 21 from the composite embedding storage 240 and transmits the extracted image composite embeddings to the multimodal similarity measurement module 280. Specifically, an image composite embedding matching part 261 of the image composite embedding extraction module 260 extracts image composite embeddings having the same identifiers as the training images 21 received from the training data extraction module 250 from the composite embedding storage 240 and transmits the extracted image composite embeddings to the multimodal similarity measurement module 280.

Referring back to FIG. 4, functions of the multimodal similarity measurement module 280 and the error measurement module 290 will be described.

The multimodal similarity measurement module 280 measures similarity between the image composite embeddings received from the image composite embedding extraction module 260 and the natural language composite embeddings received from the natural language composite embedding generation module 270 to generate multimodal similarities. For example, when there are k+1 image composite embeddings and one natural language composite embedding, the multimodal similarity measurement module 280 generates k+1 multimodal similarities.

The error measurement module 290 measures errors of the multimodal similarities generated by the multimodal similarity measurement module 280 on the basis of ground truth information extracted from the training data storage 210. The natural language composite embedding generation module 270 trains a natural language embedding model 271 (not shown) and a key word extraction model 272 (not shown) thereof on the basis of the errors of the multimodal similarities. Through this training, the device 200 for extracting a multimodal object on the basis of composite embedding can reduce an error in multimodal object extraction based on composite embedding.

According to the second exemplary embodiment of the present invention, the image embedding model 231, the key object extraction model 232, and the object embedding model 233 of the image composite embedding generation module 230 are pretrained models, and the natural language embedding model 271 and the key word extraction model 272 are trained on the basis of errors of multimodal similarities. Compared to an embodiment where a natural language model and an image model are trained together (first exemplary embodiment), an embodiment where one model is fixed and the other model is trained (second exemplary embodiment) shows a high AI learning rate and low training complexity.

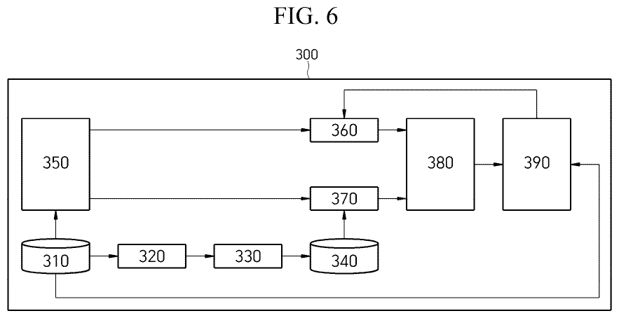

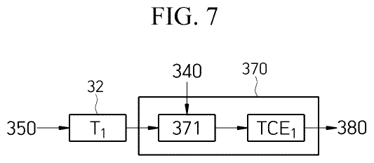

FIG. 6 is a block diagram of a device for extracting a multimodal object on the basis of composite embedding according to a third exemplary embodiment of the present invention, and FIG. 7 is a diagram illustrating a natural language composite embedding extraction process of a natural language composite embedding extraction module according to the third exemplary embodiment of the present invention.

Functions of a device 300 for extracting a multimodal object on the basis of composite embedding according to the third exemplary embodiment of the present invention will be described below with reference to FIGS. 6 and 7.

The device 300 for extracting a multimodal object on the basis of composite embedding according to the third exemplary embodiment of the present invention primarily performs a natural language composite embedding generation process and then performs an image composite embedding generation process and a natural language composite embedding extraction process.

Referring to FIG. 6, the device 300 for extracting a multimodal object on the basis of composite embedding according to an exemplary embodiment of the present invention includes a training data storage 310, a natural language extraction module 320, a natural language composite embedding generation module 330, a natural language composite embedding storage 340, a training data extraction module 350, an image composite embedding generation module 360, a natural language composite embedding extraction module 370, a multimodal similarity measurement module 380, and an error measurement module 390. The device 300 for extracting a multimodal object on the basis of composite embedding shown in FIG. 6 is in accordance with the exemplary embodiment, and components of the device 300 for extracting a multimodal object on the basis of composite embedding according to the present invention are not limited to the embodiment shown in FIG. 6, and some components may be added, changed, or removed as necessary.

The training data storage 310 stores the same data as data in the training data storage 110 of the first exemplary embodiment. In other words, the training data storage 310 stores training natural language text and training images required for training a deep learning model using supervised learning.

The natural language extraction module 320 and the natural language composite embedding generation module 330 operate prior to the training data extraction module 350, the image composite embedding generation module 360, and the natural language composite embedding extraction module 370.

The natural language extraction module 320 extracts natural language text 32 from the training data storage 310 and transmits the training natural language text 32 to the natural language composite embedding generation module 330, and the natural language composite embedding generation module 330 generates natural language composite embeddings on the basis of the training natural language text 32 and stores the natural language composite embeddings in the natural language composite embedding storage 340.

The natural language composite embedding generation module 330 has the same components and functions as those of the natural language composite embedding generation module 140. Accordingly, detailed description thereof will be omitted here. However, a natural language embedding module 331 (not shown) and a key word extraction model 332 (not shown) included in the natural language composite embedding generation module 330 may be pretrained models. This is because the device 300 for extracting a multimodal object on the basis of composite embedding only trains deep learning models of the image composite embedding generation module 360 on the basis of errors of the error measurement module 390.

The operations of the natural language extraction module 320 and the natural language composite embedding generation module 330 described above may be performed for all training natural language text 32 stored in the training data storage 310. In other words, the natural language composite embedding generation module 330 may generate natural language composite embeddings for all the training natural language text 32 stored in the training data storage 310 and store the natural language composite embeddings in the natural language composite embedding storage 340. The training natural language text 32 of the training data storage 310 and the natural language composite embeddings which are generated on the basis of the training natural language text 32 and stored in the natural language composite embedding storage 340 may be matched to each other through the same identifiers. In other words, the natural language composite embedding generation module 330 may assign the same identifier to the training natural language text 32 and a natural language composite embedding to store the natural language composite embedding in the natural language composite embedding storage 340.

Meanwhile, the training data extraction module 350 extracts the training natural language text 32 from the training data storage 310, transmits the training natural language text 32 to the natural language composite embedding extraction module 370, extracts one positive image related to the extracted the training natural language text 32 and k negative images unrelated to the extracted the training natural language text 32, that is, training images 31 (not shown), from the training data storage 310, and transmits the training images 31 to the image composite embedding generation module 360. k is a natural number of 1 or more. The training data extraction module 250 may compare words included in the training natural language text 32 with image information included in the training images 31 to determine whether the words are related to the image information.

Since the process in which the image composite embedding generation module 360 generates image composite embeddings on the basis of the training images 31 and transmits the image composite embeddings to the multimodal similarity measurement module 380 is the same as the process in which the image composite embedding generation module 130 generates image composite embeddings on the basis of the training images 11 and transmits the image composite embeddings to the multimodal similarity measurement module 150, detailed description thereof will be omitted here.

As shown in FIG. 7, a natural language composite embedding matching part 371 of the natural language composite embedding extraction module 370 extracts a natural language composite embedding TCE₁ having the same identifier as the training natural language text 32 from the natural language composite embedding storage 340 and transmits the extracted natural language composite embedding TCE₁ to the multimodal similarity measurement module 380.

Referring back to FIG. 6, functions of the multimodal similarity measurement module 380 and the error measurement module 390 will be described.

The multimodal similarity measurement module 380 measures similarity between natural language composite embeddings and image composite embeddings to generate multimodal similarities.

The error measurement module 390 measures errors of the multimodal similarities generated by the multimodal similarity measurement module 380 on the basis of ground truth information extracted from the training data storage 310. The image composite embedding generation module 360 trains an image embedding model 361 (not shown), a key object extraction model 362 (not shown), and an object embedding model 363 (not shown) thereof on the basis of the errors of the multimodal similarities. Through this training, the device 300 for extracting a multimodal object on the basis of composite embedding can reduce an error in multimodal object extraction based on composite embedding.

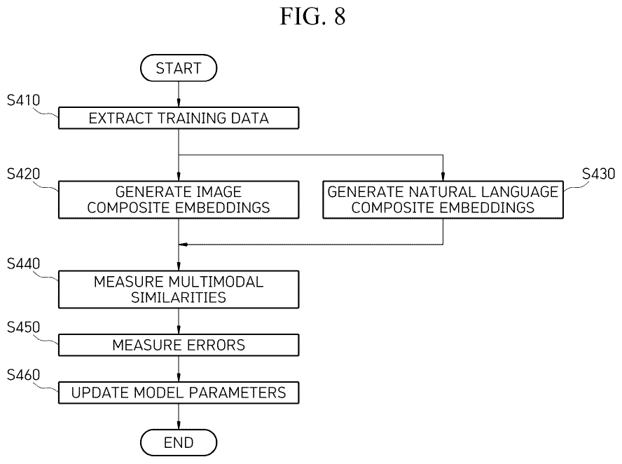

FIG. 8 is a flowchart illustrating a method of extracting a multimodal object on the basis of composite embedding according to the first exemplary embodiment of the present invention.

Referring to FIG. 8, the method of extracting a multimodal object on the basis of composite embedding according to the first exemplary embodiment of the present invention includes operations S410 to S460. Operations S420 and S430 may be performed in parallel. The method of extracting a multimodal object on the basis of composite embedding shown in FIG. 8 is in accordance with the exemplary embodiment, and operations of the method of extracting a multimodal object on the basis of composite embedding according to the present invention are not limited to the embodiment shown in FIG. 8 and may be added, changed, or removed as necessary. The method of extracting a multimodal object on the basis of composite embedding shown in FIG. 8 is performed by the device 100 for extracting a multimodal object on the basis of composite embedding.

Operation S410 is a training data extraction operation.

The training data extraction module 120 extracts training natural language text 12 from the training data storage 110 and extracts one positive image related to the training natural language text 12 extracted from the training data storage 110 and k negative images unrelated to the extracted training natural language text 12. Here, k is a natural number of 1 or more. The positive image and the plurality of negative images are training images 11.

Operation S420 is an image composite embedding generation operation.

The image composite embedding generation module 130 generates k+1 image composite embeddings using the image embedding model 131, the key object extraction model 132, and the object embedding model 133 on the basis of the training images 11 received from the training data extraction module 120. Details of operation S420 has been described above with reference to FIGS. 1 to 3 and thus will be omitted here.

Operation S430 is a natural language composite embedding generation operation.

The natural language composite embedding generation module 140 generates a natural language composite embedding using the natural language embedding model 141 and the key word extraction model 142 on the basis of the training natural language text 12 received from the training data extraction module 120. Details of operation S430 has been described above with reference to FIGS. 1 to 3 and thus will be omitted here.

Operation S440 is a multimodal similarity measurement operation.

The multimodal similarity measurement module 150 measures similarity between the natural language composite embedding and each of the image composite embeddings. In other words, the multimodal similarity measurement module 150 generates k+1 multimodal similarities by measuring similarity between one natural language composite embedding and the k+1 image composite embeddings.

Operation S450 is an error measurement operation.

The error measurement module 160 measures errors of the multimodal similarities generated by the multimodal similarity measurement module 150 using the multimodal similarities and ground truth information extracted from the training data storage 110.

Operation S460 is an operation of updating model parameters.

The image composite embedding generation module 130 trains the image embedding model 131, the key object extraction model 132, and the object embedding model 133 on the basis of the measured errors, and the natural language composite embedding generation module 140 trains the natural language embedding model 141 and the key word extraction model 142 on the basis of the measured errors.

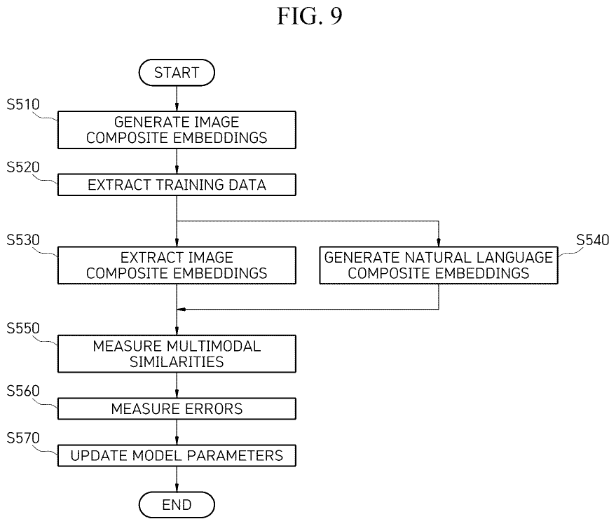

FIG. 9 is a flowchart illustrating a method of extracting a multimodal object on the basis of composite embedding according to the second exemplary embodiment of the present invention.

Referring to FIG. 9, the method of extracting a multimodal object on the basis of composite embedding according to the second exemplary embodiment of the present invention includes operations S510 to S570. Operations S530 and S540 may be performed in parallel. The method of extracting a multimodal object on the basis of composite embedding shown in FIG. 9 is in accordance with the exemplary embodiment, and operations of the method of extracting a multimodal object on the basis of composite embedding according to the present invention are not limited to the embodiment shown in FIG. 9 and may be added, changed, or removed as necessary. The method of extracting a multimodal object on the basis of composite embedding shown in FIG. 9 is performed by the device 200 for extracting a multimodal object on the basis of composite embedding.

Operation S510 is an image composite embedding generation operation.

The image extraction module 220 extracts training images 21 from the training data storage 210 and transmits the training images 21 to the image composite embedding generation module 230, and the image composite embedding generation module 230 generates image composite embeddings on the basis of the training images 21 and stores the image composite embeddings in the image composite embedding storage 240. Since the process in which the image composite embedding generation module 230 generates image composite embeddings is the same as the process in which the image composite embedding generation module 130 generates image composite embeddings, detailed description thereof will be omitted here.

Operation S520 is a training data extraction operation.

The training data extraction module 250 extracts training natural language text 22 from the training data storage 210 to transmit the training natural language text 22 to the natural language composite embedding generation module 270 and extracts one positive image related to the extracted training natural language text 22 and k negative images unrelated to the extracted training natural language text 22, that is, training images 21, from the training data storage 210 to transmit the training images 21 to the image composite embedding extraction module 260.

Operation S530 is an image composite embedding extraction operation.

The image composite embedding extraction module 260 extracts image composite embeddings (e.g., PICE₁, NICE₁, . . . , and NICEₖ) having the same identifiers as images (e.g., PI₁, NI₁, . . . , and NIₖ) included in the training images 21 from the composite embedding storage 240 and transmits the extracted image composite embeddings to the multimodal similarity measurement module 280.

Operation S540 is a natural language composite embedding generation operation.

The natural language composite embedding generation module 270 generates natural language composite embeddings on the basis of the training natural language text 22 and transmits the natural language composite embeddings to the multimodal similarity measurement module 280. Since the process in which the natural language composite embedding generation module 270 generates natural language composite embeddings on the basis of the training natural language text 22 and transmits the natural language composite embeddings to the multimodal similarity measurement module 280 is the same as the process in which the natural language composite embedding generation module 140 generates natural language composite embeddings and transmits the natural language composite embeddings to the multimodal similarity measurement module 150, detailed description thereof will be omitted here.

Operation S550 is a multimodal similarity measurement operation.

The multimodal similarity measurement module 280 measures similarity between the image composite embeddings received from the image composite embedding extraction module 260 and the natural language composite embeddings received from the natural language composite embedding generation module 270 to generate multimodal similarities.

Operation S560 is an error measurement operation.

The error measurement module 290 measures errors of the multimodal similarities generated by the multimodal similarity measurement module 280 on the basis of ground truth information extracted from the training data storage 210.

Operation S570 is an operation of updating model parameters.

The natural language composite embedding generation module 270 updates parameters of the natural language embedding model 271 (not shown) and the key word extraction model 272 (not shown) thereof on the basis of the errors of the multimodal similarities.

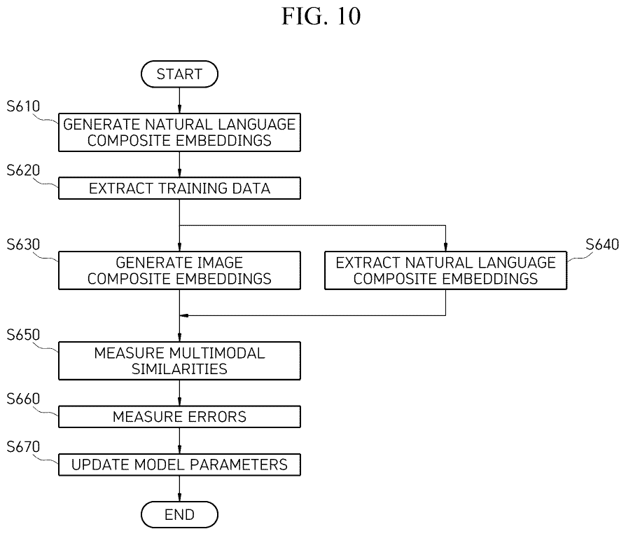

FIG. 10 is a flowchart illustrating a method of extracting a multimodal object on the basis of composite embedding according to the third exemplary embodiment of the present invention.

Referring to FIG. 10, the method of extracting a multimodal object on the basis of composite embedding according to the third exemplary embodiment of the present invention includes operations S610 to S670. Operations S630 and S640 may be performed in parallel. The method of extracting a multimodal object on the basis of composite embedding shown in FIG. 10 is in accordance with the exemplary embodiment, and operations of the method of extracting a multimodal object on the basis of composite embedding according to the present invention are not limited to the embodiment shown in FIG. 10 and may be added, changed, or removed as necessary. The method of extracting a multimodal object on the basis of composite embedding shown in FIG. 10 is performed by the device 300 for extracting a multimodal object on the basis of composite embedding.

Operation S610 is a natural language composite embedding generation operation.

The natural language extraction module 320 extracts training natural language text 32 from the training data storage 310 and transmits the training natural language text 32 to the natural language composite embedding generation module 330, and the natural language composite embedding generation module 330 generates natural language composite embeddings on the basis of the training natural language text 32 and stores the natural language composite embeddings in the natural language composite embedding storage 340. Since the process in which the natural language composite embedding generation module 330 generates natural language composite embeddings is the same as the process in which the natural language composite embedding generation module 140 generates natural language composite embeddings, detailed description thereof will be omitted here.

Operation S620 is a training data extraction operation.

The training data extraction module 350 extracts the training natural language text 32 from the training data storage 310 to transmit the training natural language text 32 to the natural language composite embedding extraction module 370 and extracts one positive image related to the extracted the training natural language text 32 and k negative images unrelated to the extracted the training natural language text 32, that is, training images 31, from the training data storage 310 to transmit the training images 31 to the image composite embedding generation module 360.

Operation S630 is an image composite embedding generation operation.

The image composite embedding generation module 360 generates image composite embeddings on the basis of the training images 31 and transmits the image composite embeddings to the multimodal similarity measurement module 380. Since the process in which the image composite embedding generation module 360 generates image composite embeddings on the basis of the training images 31 and transmits the image composite embeddings to the multimodal similarity measurement module 380 is the same as the process in which the image composite embedding generation module 130 generates image composite embeddings on the basis of the training images 11 and transmits the image composite embeddings to the multimodal similarity measurement module 150, detailed description thereof will be omitted here.

Operation S640 is a natural language composite embedding extraction operation.

The natural language composite embedding extraction module 370 extracts a natural language composite embedding TCE₁ having the same identifier as the training natural language text 32 from the natural language composite embedding storage 340 and transmits the extracted natural language composite embedding TCE₁ to the multimodal similarity measurement module 380.

Operation S650 is a multimodal similarity measurement operation.

The multimodal similarity measurement module 380 measures similarity between the image composite embeddings received from the image composite embedding generation module 360 and the natural language composite embedding received from the natural language composite embedding extraction module 370 to generate multimodal similarities.

Operation S660 is an error measurement operation.

The error measurement module 390 measures errors of the multimodal similarities generated by the multimodal similarity measurement module 380 on the basis of ground truth information extracted from the training data storage 310.

Operation S670 is an operation of updating model parameters.

The image composite embedding generation module 360 updates parameters of the image embedding model 361, the key object extraction model 362, and the object embedding model 363 thereof on the basis of the errors of the multimodal similarities.

The methods of extracting a multimodal object on the basis of composite embedding according to the first exemplary embodiment, the second exemplary embodiment, and the third exemplary embodiment of the present invention have been described with reference to the flowcharts shown in FIGS. 8 to 10. Although the methods have been illustrated as a series of blocks and described for convenience, the present invention is not limited to the order of the blocks. Some blocks may be performed in a different order than shown and described herein or performed at the same time as other blocks, and various other branches, flow paths, and sequences of blocks that achieve the same or similar results may be implemented. Also, not all the blocks shown in the drawing may be required for implementing the methods described herein.

In the description of FIGS. 8 to 10, according to implementation of the present invention, each operation may be subdivided into additional operations, or the operations may be combined into fewer operations. As necessary, some operations may be omitted, and the sequence of operations may be changed. Also, the description of FIGS. 1 to 7 is applicable to FIGS. 8 to 10 even if omitted. The description of FIGS. 8 to 10 is likewise applicable to the description of FIGS. 1 to 7.

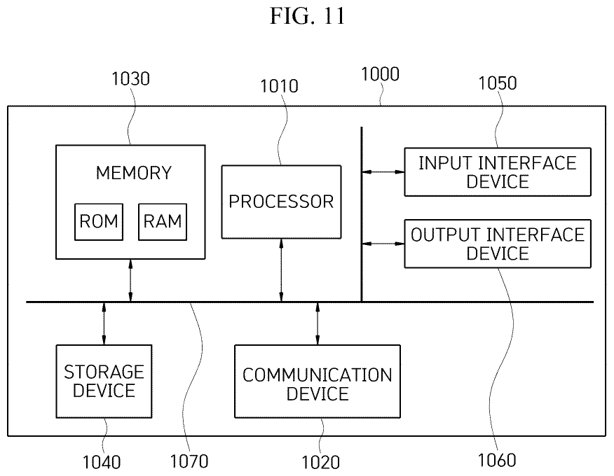

FIG. 11 is a block diagram of a computer system for implementing a method of extracting a multimodal object on the basis of composite embedding according to an exemplary embodiment of the present invention.

The devices 100, 200, and 300 for extracting a multimodal object on the basis of composite embedding according to the present invention may be implemented in the form of a computer system shown in FIG. 11. Each of the storages 110, 210, 240, 310, and 340 may be implemented as a memory 1030 or a storage device 1040 of the computer system 1000, and each of the modules 120, 130, 140, 150, 160, 220, 230, 250, 260, 270, 280, 290, 320, 330, 350, 360, 370, 380, and 390 may be implemented when a processor 1010 of the computer system 1000 executes a readable instruction (program) stored in the memory 1030.

Referring to FIG. 11, the computer system 1000 may include at least one of the processor 1010, the memory 1030, an input interface device 1050, an output interface device 1060, and a storage device 1040 that communicate via a bus 1070. The computer system 1000 may further include a communication device 1020 connected to a network. The processor 1010 may be a central processing unit (CPU) or a semiconductor device that executes computer-readable instructions stored in the memory 1030 or the storage device 1040. The memory 1030 and the storage device 1040 may include various forms of volatile or non-volatile storage media. For example, the memory 1030 may include a read-only memory (ROM) and a random access memory (RAM). In an exemplary embodiment of the present disclosure, the memory 1030 may be inside or outside the processor 1010 and connected to the processor 1010 via various known devices. The memory 1030 is any of a variety of forms of volatile or non-volatile storage media. For example, the memory 1030 may include a ROM or a RAM.

Therefore, an exemplary embodiment of the present invention may be implemented as a method implemented by a computer or as a non-transitory computer-readable medium in which computer-executable instructions are stored. In an exemplary embodiment, when executed by the processor 1010, the computer-readable instructions may perform a method according to at least one aspect of the present disclosure.

The communication device 1020 may transmit or receive a wired signal or a wireless signal.

The method according to an exemplary embodiment of the present invention can be implemented in the form of program instructions that are executable by various computing devices and recorded on a computer-readable medium.

The computer-readable medium may include program instructions, data files, data structures, and the like solely or in combination. The program instructions recorded on the computer-readable medium may be specially designed for exemplary embodiments of the present invention or well known and available to those of ordinary skill in the field of computer software. The computer-readable recording medium may include a hardware device configured to store and execute program instructions. Examples of the computer-readable recording medium may be magnetic media such as a hard disk, a floppy disk, and magnetic tape, optical media such as a CD-ROM and a DVD, magneto-optical media such as a floptical disk, a ROM, a RAM, a flash memory, and the like. The program instructions may include not only machine code such as that generated by a compiler but also high-level language code that is executable by a computer using an interpreter or the like.

A device 400 for extracting a multimodal object on the basis of composite embedding according to an exemplary embodiment of the present invention may include a memory that stores computer-readable instructions and at least one processor that executes the instructions.

In this case, by executing the instructions, the at least one processor may extract training natural language text and training images from a training data storage, generate image composite embeddings including embeddings of the training images and key objects included in the training images, generate natural language composite embeddings including embeddings of the training natural language text and key words included in the training natural language text, and measure multimodal similarities between the image composite embeddings and the natural language composite embeddings.

The at least one processor may measure errors of the multimodal similarities on the basis of ground truth information extracted from the training data storage.

The at least one processor may extract a positive image related to the training natural language text from the training data storage, extract one or more negative images unrelated to the training natural language text from the training data storage, and configure the training images including the positive image and the negative images.

The at least one processor may generate image embeddings for the training images using an image embedding model, extract the key objects from the training images using a key object extraction model, generate key object embeddings which are the embeddings for the key objects using a key object embedding model, and generate the image composite embeddings on the basis of the image embeddings and the key object embeddings.

The at least one processor may generate natural language embeddings which are embeddings of the training natural language text using a natural language embedding model, extract the key words of the training natural language text using a key word extraction model, generate key word embeddings which are the embeddings of the key words using the natural language embedding model, and generate the natural language composite embeddings on the basis of the natural language embeddings and the key word embeddings.

The at least one processor may update parameters of the image embedding model and the key object embedding model on the basis of the errors of the multimodal similarities.

The at least one processor may update parameters of the natural language embedding model on the basis of the errors of the multimodal similarities.

A device 500 for extracting a multimodal object on the basis of composite embedding according to an exemplary embodiment of the present invention may include a memory that stores computer-readable instructions and at least one processor that executes the instructions.

By executing the instructions, the at least one processor may generate, for each of training images stored in a training data storage, image composite embeddings including image embeddings for all the training images and key object embeddings which are embeddings of key objects included in all the training images and store the image composite embeddings in an image composite embedding storage, extract training natural language text and one or more training images from the training data storage, generate natural language composite embeddings including embeddings of the training natural language text and key words included in the training natural language text, extract image composite embeddings matching the one or more training images from the image composite embedding storage, and measure multimodal similarities between the image composite embeddings matching the one or more training images and the natural language composite embeddings.

The at least one processor may generate the image embeddings using an image embedding model, extract the key objects from all the training images using a key object extraction model, generate the key object embeddings using a key object embedding model, and generate the image composite embeddings on the basis of the image embeddings and the key object embeddings.

The image embedding model and the key object embedding model may be pretrained models.

The at least one processor may generate natural language embeddings which are the embeddings of the training natural language text using a natural language embedding model, extract the key words of the training natural language text using a key word extraction model, generate key word embeddings which are the embeddings of the key words using the natural language embedding model, generate the natural language composite embeddings on the basis of the natural language embeddings and the key word embeddings, and update parameters of the natural language embedding model on the basis of errors of the multimodal similarities.

A method of extracting a multimodal object on the basis of composite embedding according to an exemplary embodiment of the present invention is performed by a device 600 that includes a memory for storing computer-readable instructions and at least one processor for executing the instructions.

The method may include an operation of extracting, by the device 600, training natural language text and training images from a training data storage, an operation of generating, by the device 600, image composite embeddings including embeddings of the training images and key objects included in the training images, an operation of generating, by the device 600, natural language composite embeddings including embeddings of the training natural language text and key words included in the training natural language text, and an operation of measuring, by the device 600, multimodal similarities between the image composite embeddings and the natural language composite embeddings.

The method may further include an operation of measuring, by the device 600, errors of the multimodal similarities on the basis of ground truth information extracted from the training data storage.

In the operation of extracting the training natural language text and the training images, the device 600 may extract a positive image related to the training natural language text from the training data storage, extract one or more negative images unrelated to the training natural language text from the training data storage, and configure the training images including the positive image and the negative images.

In the operation of generating the image composite embedding, the device 600 may generate image embeddings for the training images using an image embedding model, extract the key objects from the training images using a key object extraction model, generate key object embeddings which are the embeddings for the key objects using a key object embedding model, and generate the image composite embeddings on the basis of the image embeddings and the key object embeddings.

In the operation of generating the natural language composite embedding, the device 600 may generate natural language embeddings which are the embeddings of the training natural language text using a natural language embedding model, extract key words of the training natural language text using a key word extraction model, generate key word embeddings which are embeddings of the key words using the natural language embedding model, and generate the natural language composite embedding on the basis of the natural language embeddings and the key word embeddings.

The method may further include an operation in which the device 600 updates parameters of the image embedding model and the key object embedding model on the basis of the errors of the multimodal similarities.

The method may further include an operation in which the device 600 updates parameters of the natural language embedding model on the basis of the errors of the multimodal similarities.

For reference, components according to embodiments of the present invention may be implemented in the form of software or hardware, such as a digital signal processor (DSP), a field programmable gate array (FPGA), or an application specific integrated circuit (ASIC), and perform certain roles.

However, the term “components” is not limited to software or hardware, and each component may be formed to be in an addressable storage medium or to operate one or more processors.

Therefore, examples of components may include software components, object-oriented software components, class components, task components, processes, functions, attributes, procedures, subroutines, segments of program code, drivers, firmware, microcode, circuits, data, databases, data structures, tables, arrays, and variables.

Components and functionality provided in the components may be combined into fewer components or may be further subdivided into additional components.

Meanwhile, it should be understood that each block of flowcharts and combinations of the flowcharts may be performed by computer program instructions. These computer program instructions may be loaded onto a processor of a general-purpose computer, a special-purpose computer, or other programmable data processing equipment, and thus the instructions executed by the processor of the computer or other programmable data processing equipment create elements to perform functions described in the block(s) of the flowcharts. The computer program instructions may also be loaded on a computer or other programmable data processing equipment. Accordingly, a series of operations is performed on the computer or other programmable data processing equipment to create a computer-executed process such that instructions for operating the computer or other programmable data processing equipment may provide operations for performing functions described in the flowchart block(s).

In addition, each block may represent a module, a segment, or a portion of code that includes one or more executable instructions for executing specified logical function(s). In some implementation examples, it is also to be noted that functions described in blocks may occur out of order. For example, two blocks shown in succession may be performed substantially concurrently, or the blocks may sometimes be performed in reverse order depending on the corresponding functions.

The term “module” used in the present embodiment refers to software or a hardware component, such as an FPGA or ASIC, and a “module” performs certain roles. However, a “module” is not limited to software or hardware. A “module” may be configured to be in an addressable storage and configured to operate one or more processors. For example, a “module” may include components, such as software components, object-oriented software components, class components, and task components, processes, functions, attributes, procedures, subroutines, segments of program code, drivers, firmware, microcode, circuitry, data, databases, data structures, tables, arrays, and variables. Components and functionality provided in “modules” may be combined into fewer components and “modules” or may be further subdivided into additional components and “modules.” In addition, components and “modules” may be implemented to operate one or more CPUs in a device or secure multimedia card.

According to the present invention, key words of a natural language and key object information of an image are utilized in multimodal object extraction, and thus accuracy is improved compared to multimodal object extraction in which only the whole natural language and the whole image are utilized.

Effects of the present invention are not limited to that described above, and other effects which have not been described will be clearly understood by those of ordinary skill in the art from the above description.

Although exemplary embodiments of the present invention have been described above, those of ordinary skill in the art should understand that various modifications and alterations can be made without departing from the spirit and scope of the present invention stated in the following claims.

What is claimed is:

1. A device for extracting a multimodal object on the basis of composite embedding, the device comprising:
a memory configured to store computer-readable instructions; and
at least one processor configured to execute the instructions,
wherein the at least one processor executes the instructions to:
extract training natural language text and training images from a training data storage;
generate image composite embeddings including embeddings of the training images and key objects included in the training images;
generate natural language composite embeddings including embeddings of the training natural language text and key words included in the training natural language text; and
measure multimodal similarities between the image composite embeddings and the natural language composite embeddings.

2. The device of claim 1, wherein the at least one processor measures errors of the multimodal similarities on the basis of ground truth information extracted from the training data storage.

3. The device of claim 1, wherein the at least one processor extracts a positive image related to the training natural language text from the training data storage, extracts one or more negative images unrelated to the training natural language text from the training data storage, and configures the training images including the positive image and the negative images.

4. The device of claim 1, wherein the at least one processor generates image embeddings for the training images using an image embedding model, extracts the key objects from the training images using a key object extraction model, generates key object embeddings which are the embeddings for the key objects using a key object embedding model, and generates the image composite embeddings on the basis of the image embeddings and the key object embeddings.

5. The device of claim 1, wherein the at least one processor generates natural language embeddings which are the embeddings of the training natural language text using a natural language embedding model, extracts the key words of the training natural language text using a key word extraction model, generates key word embeddings which are the embeddings of the key words using the natural language embedding model, and generates the natural language composite embeddings on the basis of the natural language embeddings and the key word embeddings.

6. The device of claim 4, wherein the at least one processor updates parameters of the image embedding model and the key object embedding model on the basis of errors of the multimodal similarities.

7. The device of claim 5, wherein the at least one processor updates parameters of the natural language embedding model on the basis of errors of the multimodal similarities.

8. A device for extracting a multimodal object on the basis of composite embedding, the device comprising:
a memory configured to store computer-readable instructions; and
at least one processor configured to execute the instructions,
wherein the at least one processor executes the instructions to:
generate, for each of training images stored in a training data storage, image composite embeddings including image embeddings for all the training images and key object embeddings which are embeddings of key objects included in all the training images and stores the image composite embeddings in an image composite embedding storage;
extract training natural language text and one or more training images from the training data storage;
generate natural language composite embeddings including embeddings of the training natural language text and key words included in the training natural language text;
extract image composite embeddings matching the one or more training images from the image composite embedding storage; and
measure multimodal similarities between the image composite embeddings matching the one or more training images and the natural language composite embeddings.

9. The device of claim 8, wherein the at least one processor generates the image embeddings using an image embedding model, extracts the key objects from all the training images using a key object extraction model, generates the key object embeddings using a key object embedding model, and generates the image composite embeddings on the basis of the image embeddings and the key object embeddings.

10. The device of claim 9, wherein the image embedding model and the key object embedding model are pretrained models.

11. The device of claim 10, wherein the at least one processor generates natural language embeddings which are the embeddings of the training natural language text using a natural language embedding model, extracts the key words of the training natural language text using a key word extraction model, generates key word embeddings which are the embeddings of the key words using the natural language embedding model, generates the natural language composite embeddings on the basis of the natural language embeddings and the key word embeddings, and updates parameters of the natural language embedding model on the basis of errors of the multimodal similarities.

12. A method of extracting a multimodal object on the basis of composite embedding, the method comprising:
extracting, by a device for extracting a multimodal object on the basis of composite embedding which includes a memory for storing computer-readable instructions and at least one processor for executing the instructions, training natural language text and training images from a training data storage;
generating, by the device, image composite embeddings including embeddings of the training images and key objects included in the training images;
generating, by the device, natural language composite embeddings including embeddings of the training natural language text and key words included in the training natural language text; and
measuring, by the device, multimodal similarities between the image composite embeddings and the natural language composite embeddings.

13. The method of claim 12, further comprising measuring, by the device, errors of the multimodal similarities on the basis of ground truth information extracted from the training data storage.

14. The method of claim 12, wherein the extracting of the training natural language text and the training images comprises extracting, by the device, a positive image related to the training natural language text from the training data storage, extracting one or more negative images unrelated to the training natural language text from the training data storage, and configuring the training images including the positive image and the negative images.

15. The method of claim 12, wherein the generating of the image composite embedding comprises generating, by the device, image embeddings for the training images using an image embedding model, extracting the key objects from the training images using a key object extraction model, generating key object embeddings which are the embeddings for the key objects using a key object embedding model, and generating the image composite embeddings on the basis of the image embeddings and the key object embeddings.

16. The method of claim 12, wherein the generating of the natural language composite embeddings comprises generating, by the device, natural language embeddings which are the embeddings of the training natural language text using a natural language embedding model, extracting the key words of the training natural language text using a key word extraction model, generating key word embeddings which are the embeddings of the key words using the natural language embedding model, and generating the natural language composite embeddings on the basis of the natural language embeddings and the key word embeddings.

17. The method of claim 15, further comprising updating, by the device, parameters of the image embedding model and the key object embedding model on the basis of errors of the multimodal similarities.

18. The method of claim 16, further comprising updating, by the device, parameters of the natural language embedding model on the basis of errors of the multimodal similarities.
